(19) United States
(12) Patent Application Publication
(10) Pub. No.: US 2017/0087873 A1
(43) Pub. Date: Mar. 30, 2017

(54) METHOD OF ABLATING AND PRINTING ON FIREARMS AND THE RESULTING PRODUCT

(71) Applicant: CUSTOM ENGRAVING, INC., Byron Center, MI (US)

(72) Inventors: Christopher S. Freybler, Dorr, MI (US); Dale A. Freybler, Wayland, MI (US)

(73) Assignee: CUSTOM ENGRAVING, INC., Byron Center, MI (US)

(21) Appl. No.: 15/201,904

(22) Filed: Jul. 5, 2016

Related U.S. Application Data
(60) Provisional application No. 62/188,935, filed on Jul. 6, 2015.

(51) Int. Cl. B41J 11/00; B23K 26/00; B41M 5/00; B44C 1/22; B41J 2/01; F41A 35/00; B23K 26/352

(52) U.S. Cl. CPC B41J 11/002; F41A 35/00; B23K 26/0084; B23K 26/352; B44C 1/228; B41J 2/01; B41M 5/0047; B41M 5/0058; B41M 5/0088

(57) ABSTRACT

A method of customizing the surface of a firearm and a resulting customized firearm includes laser ablating a predetermined metallic surface area of the firearm. An image that fits within the borders of the laser ablated surface is then ink-printed onto the laser ablated surface of the firearm.

### CLAIM OF PRIORITY

The present application claims the priority benefit under 35 U.S.C. §119 to U.S. provisional patent application No. 62/188,935, filed Jul. 6, 2015, entitled METHOD OF ABLATING AND PRINTING ON FIREARMS AND THE RESULTING PRODUCT, the entirety of which is incorporated herein by reference.

### BACKGROUND OF THE INVENTION

The present invention relates to methods of ablating and printing on a metallic surface of firearms, including pistols, revolvers, shotguns, rifles, black powder firearms, and other firearms.

Firearms can include wood and/or polymeric surfaces that can include engravings and/or color. Firearms also include metal parts that are large enough to receive an image. For example, metal parts of some firearms can be engraved with the trademark or logo of the firearm manufacturer. However, this engraving is typically rough, deep, and does not include any color. To the extent that color, lettering, logos, or other material are simply added to the surface of a firearm, such coloring can be worn off by use or cleaning of the firearm.

Many firearms are heirloom items that are passed from generation to generation and/or given as gifts. Given the aforementioned limitations of engraving and/or adding color to the metal parts of firearms, little post-sale customization of firearms has occurred.

Thus, a method for ablating and printing on metallic surfaces of firearms is described herein.

### SUMMARY OF THE INVENTION

One aspect of the present invention is a method for customizing metallic parts of firearms with an image, including a portrait, background scene, lettering, etc., in color.

Another aspect of the present invention is to provide a customized firearm with a long-lasting, color image on a metallic part of the firearm that is not susceptible to fading and/or wear during repeated use and cleaning of the firearm.

Another aspect of the present invention is to provide a method for customizing a firearm with a combination of one or more of the following features: a laser ablated surface, ink-printed image.

Yet another aspect of the present invention is a customized surface of a firearm, with a laser ablated portion of a metal surface of the firearm having a printed ink image within the boundaries of said laser ablated portion of said metal surface of said firearm.

Still another aspect of the invention is a method for customizing the surface of a firearm. A metal portion of the firearm is selected for an image and then laser ablated. The image is printed on the laser ablated portion of the firearm.

Yet another aspect of the invention is a fixture for use in the customization of the surface of a firearm. The fixture has a generally flat surface sized to receive a portion of a firearm and to fit under the heads of a laser ablation machine and/or an ink printer. The fixture has at least one adjustable support leg, an adjustment member for moving the generally flat surface along one axis, an adjustment member for moving the generally flat surface along another axis, and a level member for confirming that the generally flat surface is level when it is under the heads of the laser/or and ink printer.

These and other advantages of the invention will be further understood and appreciated by those skilled in the art by reference to the following written description, claims, and dependent drawings.

### BRIEF DESCRIPTION OF THE DRAWINGS

FIG. 1 is a perspective view of a surface having a photo jig and firearm part embodying certain aspects of the present invention;

FIG. 2 is a perspective view of the photo jig shown in FIG. 1;

FIG. 3 is a perspective view of the photo jig shown in FIGS. 1 and 2, including a firearm part positioned beneath the camera;

FIG. 4 is a perspective view of a fixture used for positioning the firearm part;

FIG. 5 is a perspective view of the firearm part positioned on the fixture shown in FIG. 4;

FIG. 6 is a top view of the firearm part with the image dimensions shown in dashed lines;

FIG. 7 is a top view of a template with the size of the image cut out of the template;

FIG. 8 is a perspective view of a fixture the holds the template shown in FIG. 7;

FIG. 9 is a perspective view of the fixture shown in FIG. 8 placed over an adjustment fixture holding the firearm part;

FIG. 10 is a perspective view of the adjustment fixture shown in FIG. 9 holding the firearm part with a mask;

FIG. 11 is a perspective view of a laser platen for positioning the adjustment fixture under the laser ablation machine;

FIG. 12 is an image of the adjustment fixture shown in FIGS. 9 and 10 with the firearm part being placed beneath a laser ablating machine; and

FIG. 13 is a perspective view of the adjustment a fixture as it is placed inside an inkjet printer.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

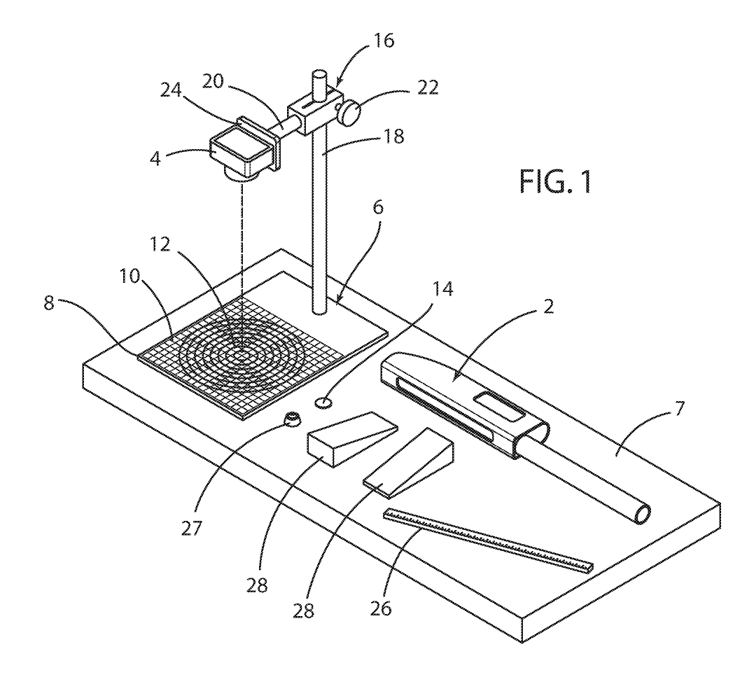

The reference numeral 2 generally designates a firearm part. The firearm part 2 is customized with an ink image that is placed on a correspondingly sized surface that has been laser ablated on the surface of the firearm part 2 and ink printed in accordance with the present invention. As shown in FIG. 1, a photograph of the firearm part 2 is taken. The photograph can be reduced in size, such as in an aspect ratio (which provides a proportion relationship between its width, its length, and its height). In addition, a computer program, such as CoreIDRAW X5 or similar software program, can be used to process the image taken with a camera 4. The camera 4 can be any camera, including a digital camera or the like. Other imaging software and cameras can be used by a person of ordinary skill in the art to achieve similar results.

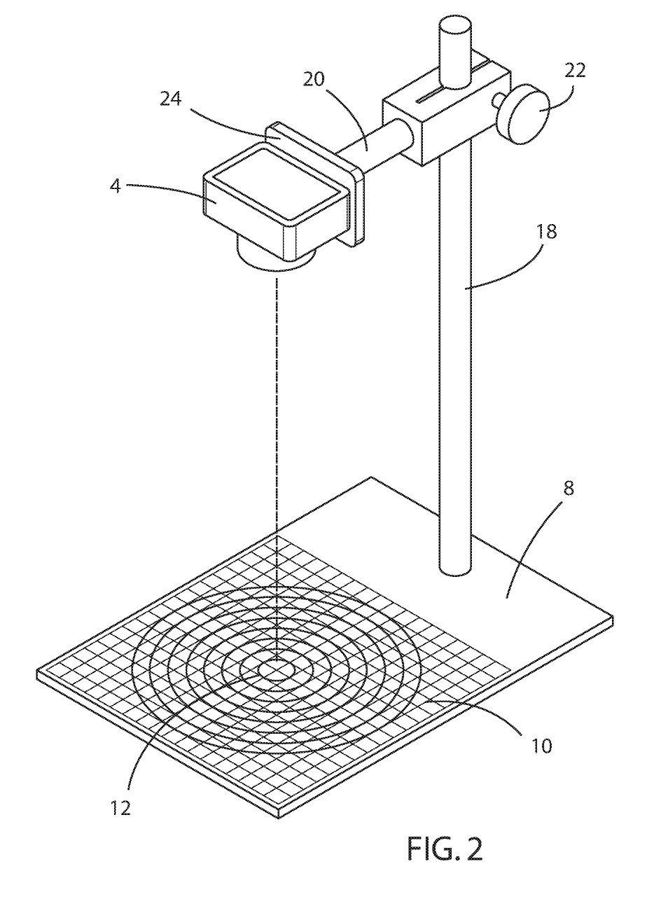

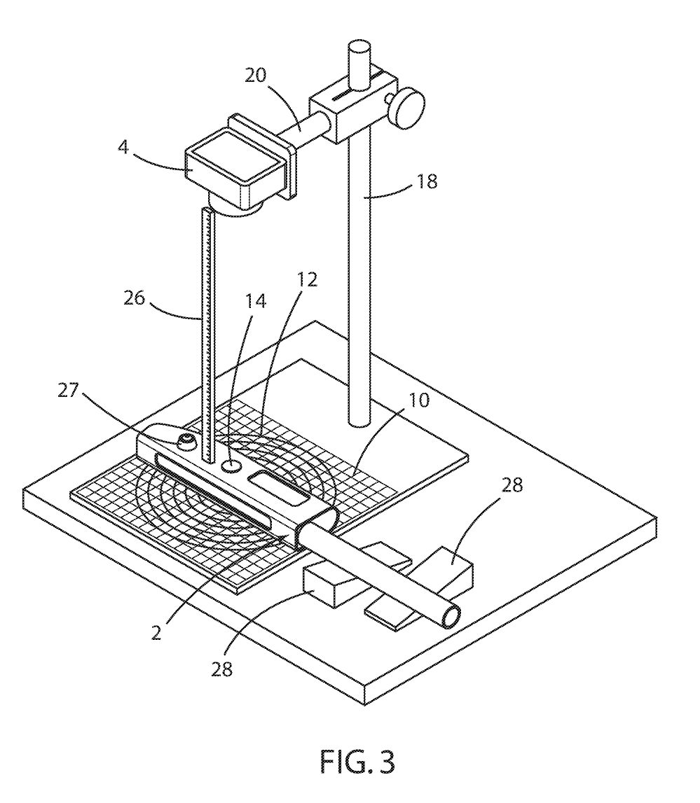

As illustrated in FIGS. 2 and 3, the firearm part 2 is leveled using a level 27 on a photo jig 6. The photo jig 6 includes a camera stand 16 with a vertical portion 18, a horizontal portion 20, and a camera mount 24. In addition, the camera stand 16 can include adjustment screws 22 that can adjust the vertical and/or horizontal positioning of the camera 4. Ideally, the camera 4 is positioned above the center of the bullseye 12 on the pad 8 of the photo jig 6. The photo jig 6 can be positioned on a surface 7 and leveled using a bubble level 27 or the like.

The leveling of the firearm part 2 on the photo jig 6 can be accomplished by any conventional means, including the utilization of wedges 28. In addition, to achieve the appropriate aspect ratio, coordinate lines 10 on the photo jig base 8 can be aligned with the firearm part 2. The camera 4 is raised until the distance between the bottom of the lens of the camera and the top of the firearm part 2 are approximately 17.8125″. A 17.8125″ premeasured stick 26 may be used to position the camera 4. While this distance is used in the illustrated embodiment, other distances may be used provided that the photograph is clear. The bullseye 12 can assist in focusing the camera 4. A US quarter 14 (0.955″ diameter) or similarly sized object may also be placed in the image to give a reference dimension on the photo. After the camera 4 is set at the correct distance from the firearm part 2, the camera 4 and base 8 can be leveled, resulting in the bottom of the camera lens and the top of the firearm part 2 being generally parallel. The picture is made as straight as possible by attempting to align the bottom line of the camera 4 such that it is parallel to the horizontal lines on the photo jig base 8. Once the camera 4 is set, the image is taken.

The digital image is then transferred to a computer using a USB drive, micro SD card, or other similar apparatus. The image photo is imported into a software program, such as CoreIDRAW or similar program. The firearm part 2 should remain straight, using a horizontal guideline or similar function in the software program. The photo percentage is then reduced under a scale factor, making sure that the features of the program result in the photo reduction being proportionate. While a 37.2% reduction may be used as a general approximation, the reduction is done to the point where the image looks good. Several points on the firearm part 2 are measured using a ruler, such as the injection port height and width, the rivet and screw locations, etc. The software program is used to create an outline of the exact edge of the firearm part 2, with the end goal being between the straight lines and curves to create a perfectly outlined firearm part 2. The position of other elements of the firearm part 2, such as rivet heads and markings (such as serial number, manufacturer information, etc.), can be noted to potentially exclude those elements from the sizing of the image 62. A border amount is then determined, which can be uniform all the way around the firearm part 2 or can be un-uniform. In addition, the border can include rounded parts and can adjust around rivet heads, serial numbers, and anything should be excluded from the ultimately ablated and printed design. Once all the dimensions are accurate and the aspect ratio is correct, the image is saved for later retrieval.

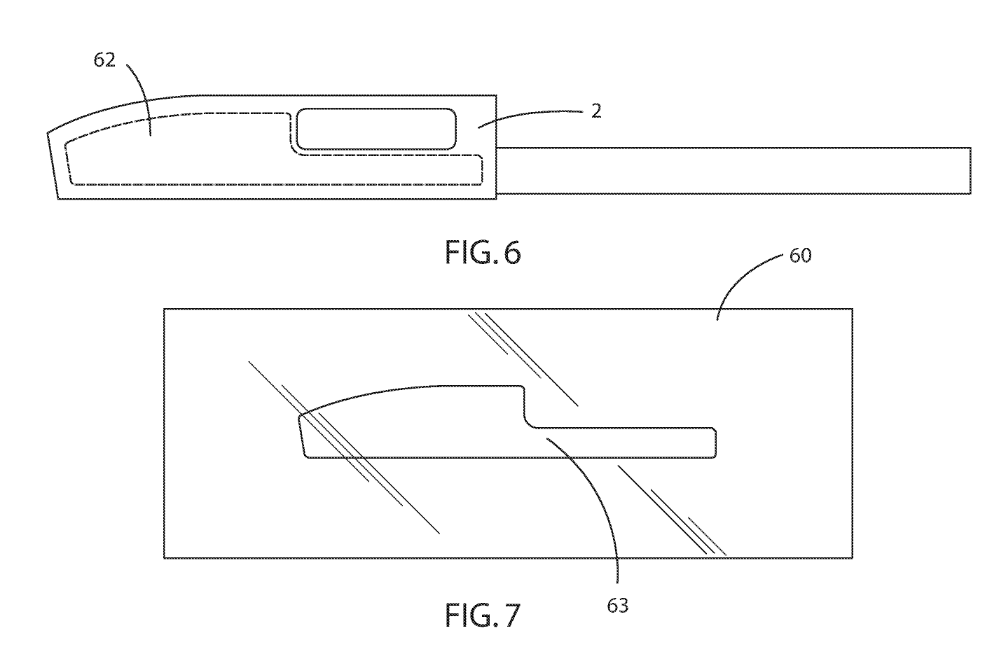

An actual sized template 60 is created. The actual sized template 60 can be made on a transparent vellum or similar material. The size of the image 62 to be placed on the firearm part 2 (FIG. 6) is cut from the template 60 leaving an aperture 63, as shown in FIG. 7. A computer program, such as CoreIDRAW X5 or the like, can be used to show what image should be cut from template 60. A laser, such as a TROTEC C02 laser, can be used to cut the template 60.

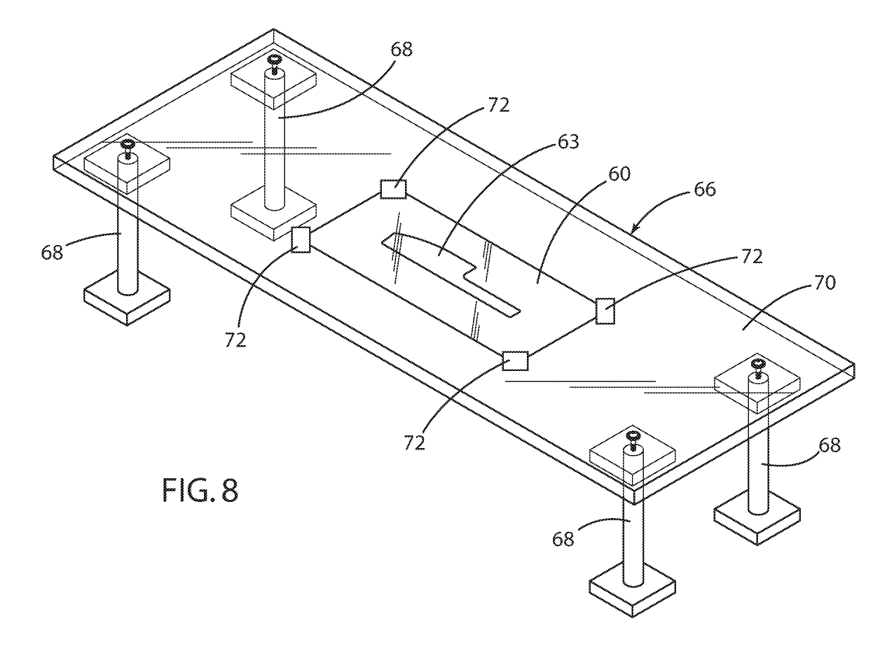

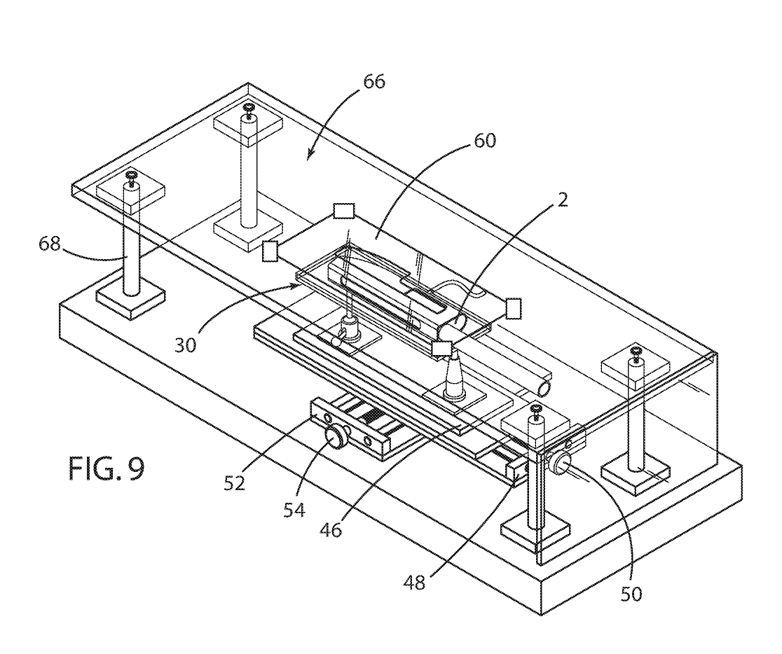

Prior to the laser ablation step, the template 60 can be placed on a stand 66, as shown in FIG. 8. This stand has legs 68 and a surface 70. The template 60, with aperture 63, is taped 72 to the surface 70 of the stand 66. The stand 66 can then be placed over the adjustment fixture 30 (FIG. 9) prior to the laser ablation step to ensure that the laser ablation machine 84 and the associated laser 86 are properly aligned with the required dimensions for the image to be placed on the firearm part 2. This optional sequence allows the image to be superimposed on the actual firearm part 2 before ablation. This template 60 and stand 66 can also be used to test the appropriate alignment before the ink printing step. Changes can be made to the template 60 by modifying the dimensions and re-cutting the template 60.

The final art for the laser ablation step and the color printing step can be created using a software program, such as Adobe Photoshop or other imaging software, to process the image. The artwork is placed on the area of the shape prepared for the template 60. Multiple pictures, text, artwork, etc., can be used or bundled together to create the final artwork image. The functions of the software program can be used to blend, edit, contrast, or otherwise tailor the artwork. The artwork is then sized such that it fits within the dimensions of the template 60 created above. The image should be sized such that its dimensions are the same size or slightly larger than the dimensions of the aperture 64 in template 60 than what was created. Thus, the final art image is manipulated so that it aligns exactly with the actual firearm part 2. The final art image and the firearm part 2 should be superimposed with a generally identical aspect ratio.

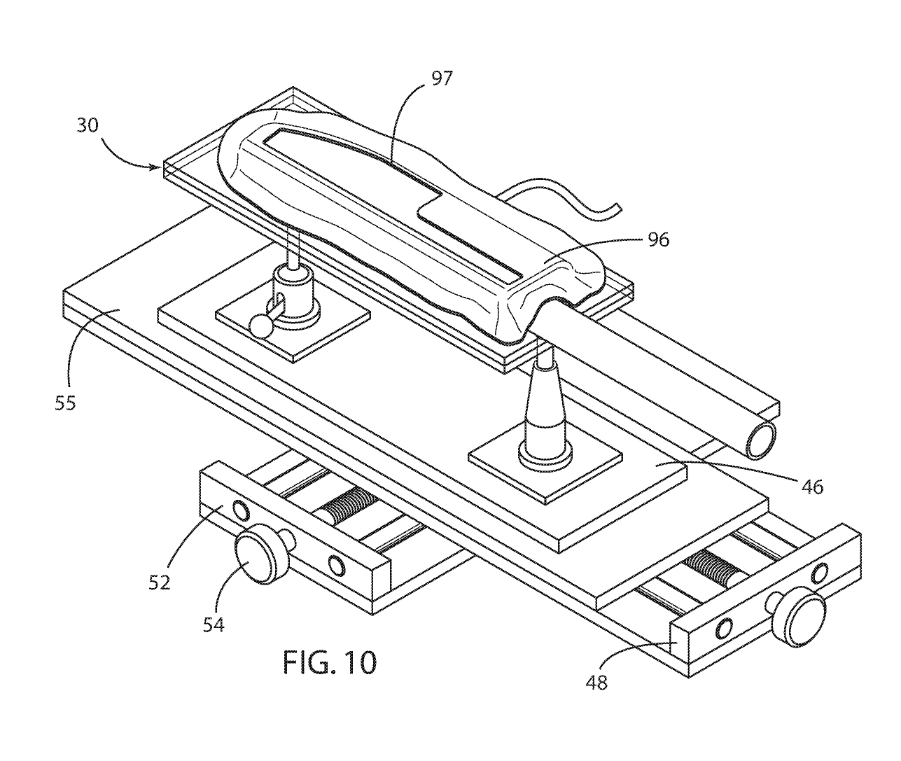

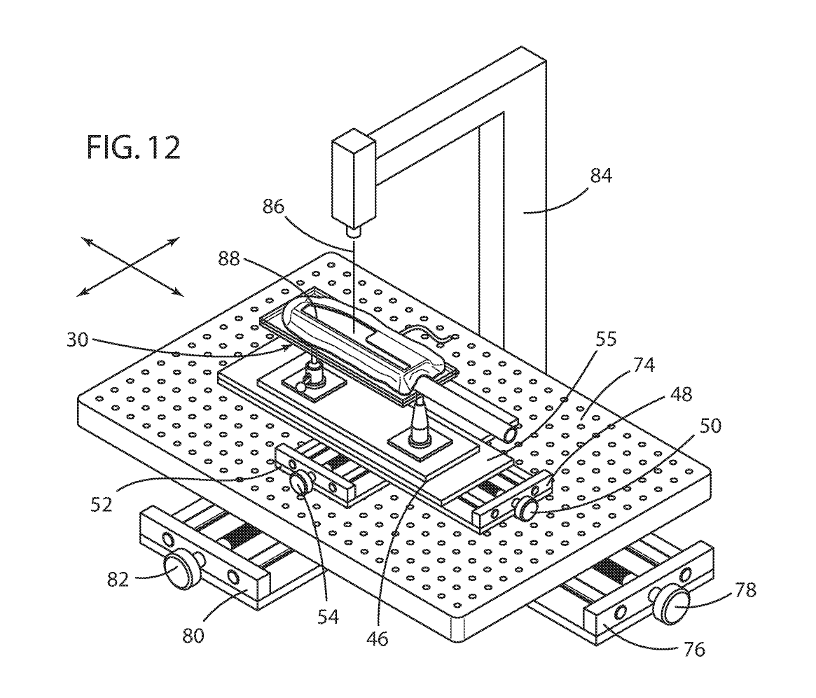

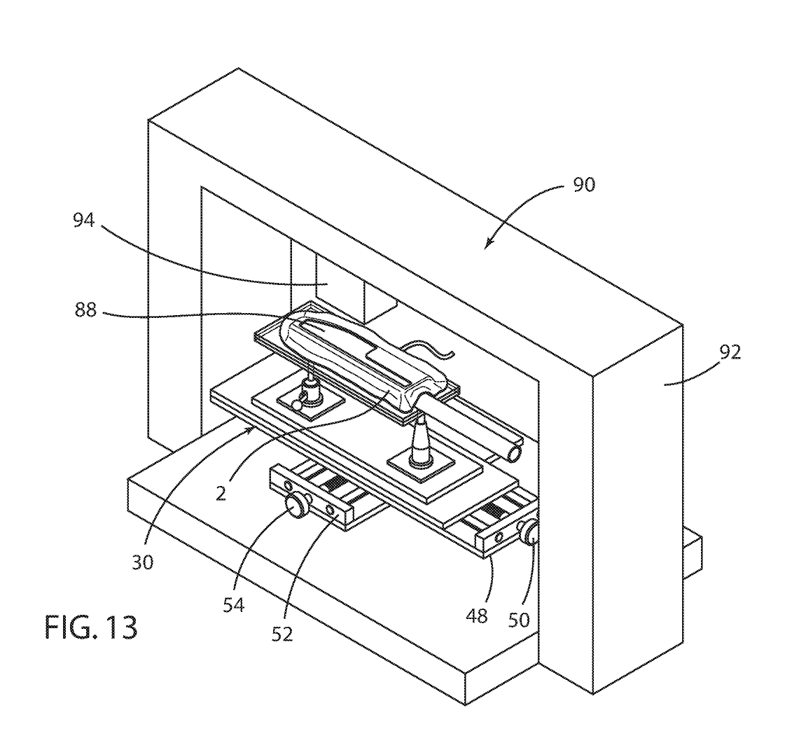

The firearm part 2 is then ready for the laser ablation step. A computer cut file is created on the laser ablation machine 84, the cut file is aligned with the firearm part 2. The laser cuts the paint mask 96 (FIGS. 10 and 12) and then ablates the firearm part 2. Any laser can be used, such as a fiber laser or the like.

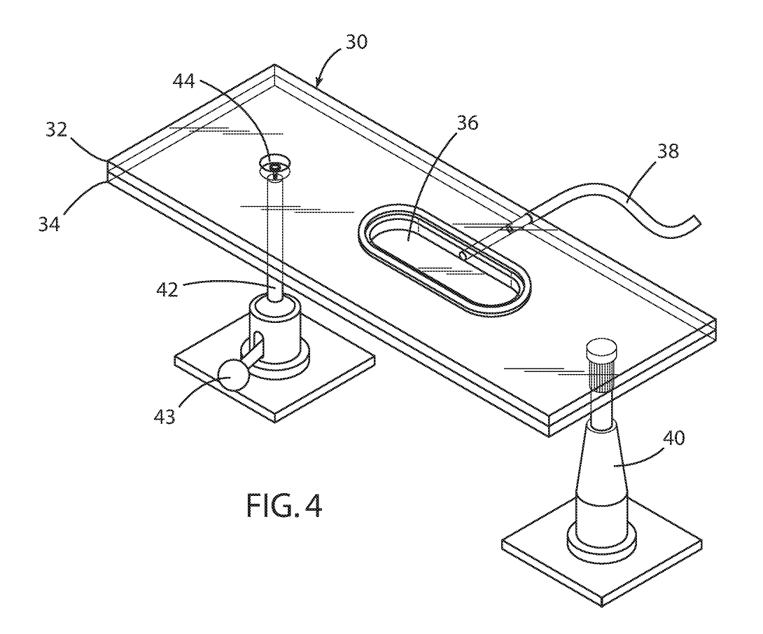

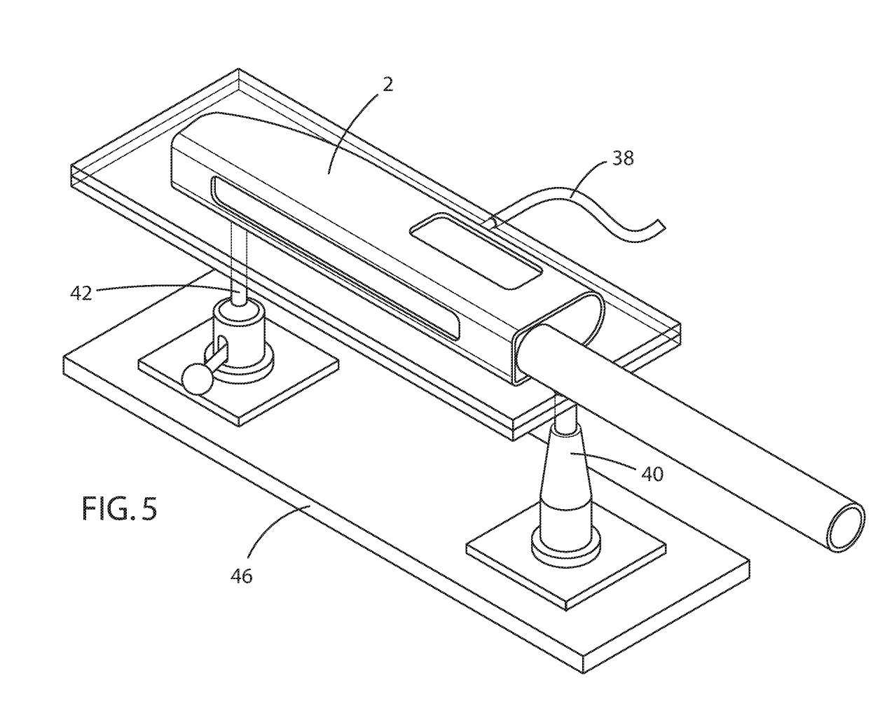

The adjustment fixture 30 and firearm part 2 are mounted on the laser platen 74 and a vacuum can be turned on and attached via a vacuum tube 38. As shown in FIG. 4, the adjustment fixture 30 includes an upper plate 32, a lower plate 34, an aperture 36, a vacuum tube 38, and one or more stands. In the illustrated embodiment, there are two stands 40, 42, one of which is adjustable via a lever 43. The other stand 40 can also be adjustable. The adjustment fixture 30 can include a level bubble 44. The adjustment fixture 30 can also be placed on a generally flat base 46, as shown in FIG. 5.

The adjustment fixture 30 also includes mechanisms for adjusting the fixture 30 along different axes. For example, one axis adjustment member 48 can include a threaded member 50 for adjustment along one axis, while the other adjustment member 52 includes a threaded member 54 for adjustment along another axis, as shown in FIGS. 9 and 10 and by the arrows in FIG. 12. These adjustment members 48, 52 can be below a surface 55 of supporting stands 40, 42. In addition, adjustment mechanisms can also be located below the laser platen 74. For example, one axis adjustment member 76 can include a threaded member 78 for adjusting one axis, while the other adjustment member 80 includes a threaded member 82 for adjustment along another axis, as shown by the arrows in FIG. 12.

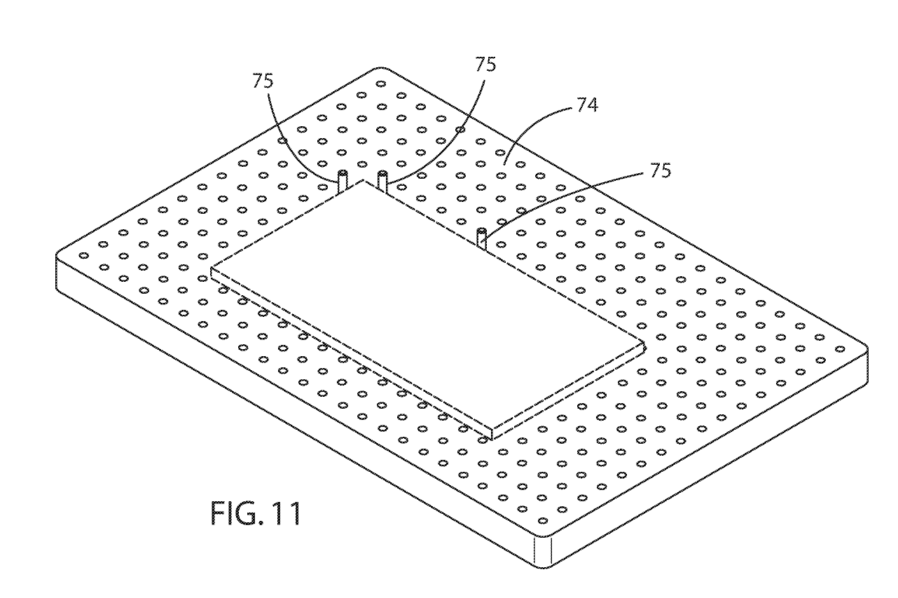

The adjustment fixture 30 is adjusted and leveled prior to the laser ablation step, as shown in FIG. 12. The adjustment fixture 30 may be placed onto a laser platen 74 and held in place with pins 75, as shown in FIGS. 11 and 12.

The paint mask 96 is placed on the firearm part 2, as shown in FIG. 10 (showing the opening 97 that ultimately is cut during the laser ablation process). The surface of the firearm part 2 can be prepared with a cleaning preparation and/or mechanical object, such as a microfiber cloth. The paint mask 96 is applied to the surface of the firearm part 2, with the mask 96 being pushed down around all rivets close to the cutting area. A laser pointer can be used to outline the rivets or holes to make sure the firearm part 2 is in the correct location. Thus, the measurements are verified and the paint mask 96 is ready to be laser cut. The portion of the mask 96 that is laser cut is then peeled away, as shown in FIGS. 10 and 12. The firearm part 2 is then laser ablated. The number of passes and the direction and depth of the passes can vary, depending upon the laser ablation machine 84 that is used. The goal is to laser ablate the surface in multiple directions to create a textured ablated surface. The surface of the firearm part 2 can then again be cleaned with a cleaning preparation and/or mechanical apparatus, such as a microfiber cloth.

Finally, the final art is printed on the ablated surface of the firearm part 2. Any inkjet printer, such as an Mimaki UV Printer, can be used. The firearm part 2 is installed in a fixture on the bed of the printer. The same adjustment fixture 30 can be used for the ink printing step. The firearm part 2 can again be cleaned with a preparation solution and/or mechanical cleaner, such as a microfiber cloth. The firearm part 2 is then put within the housing 92 of the printer 90. The artwork is then installed in the software of the inkjet printer 90. The software program for the laser printer 90 is used to verify that the size of the artwork generally matches the laser ablated surface 88. Ideally, the laser ablated surface 88 is slightly smaller than the artwork to allow for some tolerance in the printing with a small portion of the artwork being printed on the mask 96. Software is used to make sure that the pixilation, clarity, and position of the inkjet image is correct.

A primer layer may be printed onto the laser ablated surface 88 before printing the image. Alternatively, the primer layer can be applied before the firearm part 2 prior to being put into the inkjet printer 90. If the primer is being printed by the printer 90, the user can make sure the primer was centered on the ablated surface 80. If it is not, adjustments can be made. The template 60 may also be used to align the head 94 of the inkjet printer 90 prior to printing. The mask 96 remains on the firearm part 2 during the ink printing step. The artwork is then printed onto the laser ablated surface 88.

### Example 1

The following illustrated example is simply one example of how the process can be accomplished.

Phase 1: Take Photo with Photo Jig of Firearm Part.

(1) Level firearm part on photo jig utilizing wedges and bullseye. Make sure coordinate lines on photo jig base are straight with firearm part.

(2) Be sure to protect the firearm part by placing a pad between the photo jig and firearm part. Make sure pad does not hide the coordinate lines on the photo jig base.

(3) With camera on, raise the camera until the distance between the bottom of the lens and the top of the firearm part are 17.8125″. Use the 17.8125″ pre-measured stick to accomplish this. The distance of 17.8125 at this point has the clearest most accurate image.

(4) Place a US Quarter (0.955″ diameter) on the firearm part. Make sure it is not placed over any rivet holes or the firearm part outline. This will give a reference dimension on the photo.

(5) After setting camera the correct distance from the firearm part (17.8125″), level camera using the bullseye. Now the bottom of the camera lens and the top of the firearm part should be parallel.

(6) Make sure picture is straight as possible. This is accomplished by making sure the bottom line of the camera, looking at through the lens, is parallel to the horizontal bottom lines of the photo jig base.

(7) Once camera is set, take the picture.

(8) Plug the camera into the computer using the USB.

(9) Access the newly created firearm part photo and save it for later retrieval.

(10) Import the firearm part photo into CoreIDRAW—Go to File>New>File>Import>Select firearm photo and press Enter (bottom right hand corner).

(11) Verify the firearm part is straight using a Horizontal Guideline:
(a) Rotate photo 180°;
(b) Drag a guideline down from the top ruler to a straight edge of the firearm part; and
(c) Change the Angle of Rotation until straight with the guideline (found on toolbar above).

(12) Reduce Photo Percentage under the Scale Factor—Start with 37.2%.

(13) Create rectangles, squares, circles and lines in CoreIDRAW to match the measured dimensions. On the actual firearm part measure several points using a precision ruler. Examples could be: US Quarter (0.955″ diameter); overall width; overall height; ejection port height and width; rivet and screw locations and distance between them. Change the color of the boxes and circles etc. to red or yellow for better contrast so it can be seen. Use the Zoom Tool to be able to see better to superimpose the shapes.

(14) Once all dimensions are accurate and the “aspect ratio” is correct, save the photo of firearm part for later retrieval.

(15) For this embodiment we have elected to save as MASTER.cdr file. Make sure file type is .cdr.

(16) PHASE 1 is now complete.

PHASE 2: Creating an “Actual Size” Template with Crosshairs on a Transparent Vellum from the Final Art Created in PHASE 1.

(1) Open the file MASTER.cdr that was saved in PHASE 1. In CoreIDRAW go to File>Open and press Enter.

(2) Create Outline of the “exact edge” of the firearm part utilizing these steps:
(a) Draw a box and convert to curves:
   (i) Draw a box on the firearm part by using the Rectangle Tool (F6) (on the left side); and
   (ii) Convert to curves—under the Arrange Tab>Convert to Curves or (CTRL+Q);
(b) Use the Shape Tool (F10) on the left hand side to move nodes and create straight lines and curves:
   (i) To create a node, Right Click>Add or Double Click the desired location on the outline of the box.
   (ii) Use straight lines whenever possible.
   (iii) To make curves—Right Click between two nodes and move line to final location.
(c) Add circles where needed for alignment and art work design (i.e., rivet heads) using the Ellipse Tool (F7) draw rivet heads to size;
(d) Bring outline of firearm part in by ⅛″ all the way around by using the Contour Offset Tool on the left side bar:
   (i) Go to Blend Tool>Contour Tool.
   (ii) On the top toolbar change Contour Offset to 0.125″.
   (iii) With newly created outline selected, click the Inside Contour icon. This will bring the outline in by ⅛″ all the way around.
   (iv) Break contour group apart—under the Arrange Tab>Break Contour Group Apart or click (CTRL+K).
   (v) Round squared corners—zoom into corners making new nodes and round corners where needed.
   (vi) Click the SAVE button.

(3) Now that the outline is perfect, it is time to create the center point crosshair:
(a) Create a horizontal line—using the Freehand Tool (F5), click once to start line and hold CTRL while dragging and click to make the line.
(b) Make a copy of the line—while highlighting the newly created line, click (CTRL+C) and (CTRL+V).
(c) Select the newly created line and rotate it 90° on the top toolbar.
(d) Using the Pick Tool select both lines by holding Shift and group them together (CTRL+G). The intersecting lines now become one object:
   (i) Move the newly created crosshair inside the outline—Click the crosshairs and hold Shift and click the outline.
   (ii) To center the crosshairs within the outline—go to Arrange Tab>Align and Distribute>Align and Distribute. This brings up the Align and Distribute dialog box.
   (iii) In the Align and Distribute dialog box, choose Center Vertical and Center Horizontal and click Apply then Close. The crosshairs are now perfectly centered in the outline.

(4) Once the outline, circles and crosshair of the firearm part are created, it is time to engrave the image on a transparent vellum. This provides an opportunity to view it superimposed on the actual firearm part and make changes where needed. If changes need to be made to the transparent vellum, simply modify the dimensions and re-engrave the vellum until the desired Outline is achieved:
(a) Select all the created outlines, circles etc. and drag a copy to a new page and make a copy by Right clicking while still holding the Left Button on the mouse.
(b) Delete what is not needed, leaving only the outlines, rivet holes, and crosshairs. Make the outline RED and Hairline thickness. This is considered the MASTER file.
(c) Save the MASTER file to the desired location before the file is saved to the USB Drive to bring to the TROTEC to laser.
(d) Open the .CDR file on the TROTEC computer:
   (i) Print the file in CoreIDRAW so it sends a file to the TROTEC JobControl Software.
   (ii) File>Print (or printer icon)>Preferences>Change Size Settings to Page Size (8.5×11)>Material Setting to Clear Transparency>Process Mode (Standard)>Process Option (Resolution—500 DPI)>OK>Apply>Print.
   (iii) Put clear transparency in TROTEC Bed>Focus using the Silver Aluminum Focus Tool>close the laser lid.
   (iv) In JobManager double click the previously printed job, this puts the file into the active field>click once on the job to turn it black>click the play button (laser will start).
(e) Test clear transparency on firearm part to superimpose it to make sure everything was created correctly. If tweaks are made re-engrave until everything is created correctly.
(f) Make a second copy of MASTER file below and delete crosshairs and outer line leaving rivet holes and inside line ONLY, this is creating a RIVETS & OUTLINE file.
(g) Make a third copy from the previously created Outline w/Rivet Holes Only file and delete the rivet holes leaving ONLY the outline, this is called the OUTLINE file.
(h) Make a fourth copy from the previously created Outline file and fill it yellow and turn off the outline by right clicking on Clear (in the top box in the color chart); this is creating the FILLED OUTLINE file.

(5) Export two EPS files for the Artwork Design that will be used in PHASE 3. Choose a location that can be easily retrieved for PHASE 3:
(a) Select the RIVETS & OUTLINE file using the Pick Tool and Export>RIVETS & OUTLINE.eps. Go to File>Export (CTRL+E)>Make Sure File Type is .eps>Selected Only is Checked>RIVETS & OUTLINE>Export>Verify EPS Dialog box>OK.
(b) Select the FILLED OUTLINE file using the Pick Tool and Export>FILLED OUTLINE.eps. Go to File>Export (CTRL+E)>FILLED OUTLINE>Export>Verify EPS Dialog box>OK.

(6) Export two+PLT (HPGL) files for the FIBER Laser to be used in PHASE 4. Choose a location that can be easily retrieved for PHASE 4:
(a) Select the MASTER file using the Pick Tool and Export>LASER MASTER.plt. (This file has everything: Both Outlines, Rivet Holes & Crosshairs.) Go to File>Export (CTRL+E)>Make sure Selected Only is Checked>File Type is PLT (HPGL)>LASER MASTER>Export>HPGL Dialog Box>OK.
(b) Select the OUTLINE file using the Pick Tool and Export>OUTLINE.plt. (This file is internal Outline only.) Go to File>Export (CTRL+E)>OUTLINE>Export>HPGL Dialog Box>OK.
(c) Select the RIVET HOLE file(s) using the Pick Tool and Export>LG HOLE.plt. Go to File>Export (CTRL+E)>LG HOLE, MD HOLE or SM HOLE>Export>HPGL Dialog Box>OK.

(7) PHASE 2 is now complete.

PHASE 3: Preparing the Final Art to Laser Ablate in PHASE 4 and then Color Print the Firearm Part as the Finish Step in PHASE 5.

(1) In Adobe Photoshop start a new file—Go to File>New, this brings up the New Dialog Box:
(a) Name the file TEMPLATE.
(b) Create a box larger than firearm part—insert dimensions in width and height. (Example: 8×8 inches.)
(c) Set Resolution to 600 dpi.
(d) Set Color Mode to CMYK and 8 bit.
(e) In Background Content>White.
(f) Click OK—this brings up the newly created Page.

(2) Import both EPS Files saved in PHASE 2:
(a) Go to File>Place Embedded>Choose the FILLED OUTLINE.eps file and Double-Click or click Place. Click the Move Tool>Place the File? (This brings up the Place the File? dialog box) and click Place (shortcut—Click Enter); and
(b) Go to File>Place Embedded>Choose the RIVETS & OUTLINE.eps file and Double-Click or click Place. Click the Move Tool>Place the File? This brings up the Place the File? dialog box and click Place (shortcut—Click Enter).

(3) Open picture(s) and place artwork and edit/collage pictures in area of Shape. This step is where the artist takes all the photos and backgrounds and blends them together to create the final Art Image(s) PDF files.

(4) Save before merging artwork together.

(5) Now merge all photo layers together:
(a) To merge the Art Layers together: CTRL+Click on each Art Layer to select>Merge Layers (CTRL+E).
(b) Rename Layer to ART LAYER (Double Click on name to change it).

(6) Save as Merged Art as a Photoshop.PSD File.

(7) CTRL+Left Click on Smart Object Thumbnail of the Filled Outline Layer—This makes a dotted outline appear.

(8) Go to Select>Modify>Contract and set at 30. Click OK.

(9) Select the Smart Object of the Filled Outline Layer and go to Select>Refine Edge>Adjust Edge>Feather set to 20, Click OK.

(10) Go to Select>Inverse and highlight Art Layer and Delete (on keypad)—The background is now deleted.

(11) Turn Filled Outline Off by clicking the Eye Ball.

(12) (CTRL+D)—Gets rid of dotted line.

(13) Right click on the Art Layer, select Blending Options in drop down menu. Click Stroke then click right button on mouse—make sure position is outside and set size to 40. Click Color and choose whatever color the background is desired to be. Hit OK.
(a) Use the eye dropper to choose a color from the Art.
(b) The eye dropper appears when the cursor hovers over Art.

(14) CTRL+Left Click on the Smart Object Filled Outline Thumbnail.

(15) Go to Select>Inverse and highlight Art Layer and Delete (on keypad).

(16) (CTRL+D) to deselect.

(17) Using the Crop Tool (C) crop image around the shape—click Move Tool>Crop. This is where we crop the image smaller than the box size we made in 1b above.

(18) Center the Art Layer (vertically and horizontally) within the newly created Crop Box—Select Art Layer and Background by using CTRL+Click on both layers then up in the toolbar (make sure to use Pointer Tool and not Crop Tool):
(a) Select the Line Horizontal Centers Tool.
(b) Select the Line Vertical Centers Tool.

(19) Left Click>Right Click on Art Layer and in menu select Rasterize Layer Style.

(20) CTRL+Left Click on the Art Layer Thumbnail.

(21) On bottom right corner click Create a New Layer and rename layer to CYAN.

(22) In left hand menu click Set Foreground Color and set C to 100% and M, Y and K to 0%. Click OK. Grab Paint Bucket Tool in same menu.

(23) Hover over Art and Left Click to fill with color.

(24) On bottom right corner click Create a New Layer and Rename Layer to MAGENTA.

(25) In left hand menu click Set Foreground Color and set M to 100% and C, Y, and K to 0%. Click OK. Grab Paint Bucket Tool in same menu.

(26) Hover over Art and Left Click to fill with color.

(27) In top menu select Image and scroll down to Image Size. Jot down Length and Width and hit OK.

(28) Click (CTRL+D) to deselect. Click on Move Tool.

(29) Turn Eye Off on every Layer except CYAN and Background. Save As WHITE.pdf. Go to File>Save As >WHITE.pdf and choose Photoshop PDF under File Type. When dialog box appears click OK. Another dialog box will appear this time Check Preserve Photoshop Editing Capabilities, Check Embed Page Thumbnails, Check Optimize for Fast Web Preview, and Uncheck View PDF after saving. Click Save PDF.

(30) Turn Eye Off on every layer except MAGENTA and Background. Save As PRIMER.pdf. Go to File>Save As >PRIMER.pdf and choose Photoshop PDF under File Type. When dialog box appears click OK. Another dialog box will appear this time Check Preserve Photoshop Editing Capabilities, Check Embed Page Thumbnails, Check Optimize for Fast Web Preview, and Uncheck View PDF after saving. Click Save PDF.

(31) Turn Eye Off on every layer except ART LAYER and Background. Save As ART LAYER.pdf. Go to File>Save As >ART LAYER.pdf and choose Photoshop PDF under File Type. When dialog box appears click OK. Another dialog box will appear this time Check Preserve Photoshop Editing Capabilities, Check Embed Page Thumbnails, Check Optimize for Fast Web Preview, and Uncheck View PDF after saving. Click Save PDF.

(32) Make sure all the Eyeballs are turned on before final Save. Save as FINAL.psd.

(33) PHASE 3 is now complete.

PHASE 4: Using the FIBER Laser, Laser Ablate the Firearm Part in Preparation to be Color Printed in PHASE 5.

PHASE 4—Step 1—Now that the Final Art has been Created Successfully, Manipulate the Final Art Image Until it Lines Up Exactly with the Actual Firearm Part. The End Goal is to have the Final Art Image and the Firearm Part Superimposed with an Identical Aspect Ratio.

(1) Import the file LASER MASTER.plt. Go to File>Import (CTRL+I) and navigate to the file. Make sure File of Type is HPGL File.*plt (a user will now be able to see all the Vector files created for the firearm part including the Laser Master). Highlight the LASER MASTER File and click Open.

(2) Turn Outline OFF—Under the OBJECT INFO TAB (upper right)—Uncheck Mark Outline>Apply.

(3) Check sizing under the MOVE/SIZE TAB under the Outline Section (verify the Dimensions Sheet aspect ratio—X and Y dimensions—are the same as in CoreIDRAW).

(4) Import all rivet holes. LG HOLE.plt; MD HOLE.plt; SM HOLE.plt. Go to File>Import (CTRL+I) and navigate to the first rivet hole PLT (Vector Line File) then click Open. Then under the OBJECT INFO TAB—Uncheck Mark Outline>Apply. Repeat until all rivet holes have been imported.

(5) Using the Mouse, click the corner of the newly imported rivet holes and move each one close to desired location. Once they are all close, they will be moved to the exact location:
(a) Before making any moves, change the Nudge Step—With the first rivet hole selected, on the toolbar select SETTINGS>SYSTEM>VIEW TAB (Default) and change the NUDGE STEP to 0.001 for both X and Y and click Apply then OK.
(b) Use the Zoom Tool to get a better view of the rivet holes. Simply click the Zoom Tool and create a box around the area to magnify.
(c) Now select the first rivet hole circle and move it to the exact location by using the appropriate CTRL_ARROW (up, down, left, right).

(6) Import the file OUTLINE.plt.
(a) Go to File>Import>OUTLINE.plt>Open.
(b) Make sure power setting is set to Deep under the Laser TAB (Deep is always default).
(c) Change number of passes to five under the OBJECT INFO TAB>Apply.
(d) Make sure the Outline File lines up with the Master—Using the Zoom Option and Nudge Option from (5) above.
(e) Verify size to CoreIDRAW Dimensions under the MOVE/SIZE TAB.
(f) Save the file as LASER.sjf. File>Save As >Name the File>Save.

(7) Mount fixture and firearm part on the laser bed and turn vacuum on.

(8) Move the XYZ Coordinates until close to the crosshair on the vellum which has been trimmed down and aligned on the firearm part surface:
(a) Put firearm part on laser table with vellum superimposed clearly showing the crosshair. Level firearm part using fixture, screw jacks, and bullseye.
(b) In order to move the laser table so the pendulum is aligned with the crosshair, with nothing selected click on the CONTROL TAB (upper right).
(c) In the CONTROL TAB move X, Y & Z coordinates until the pendulum is aligned with the crosshair>Go.
(d) Remove Foc-Align Cap and vellum.
(e) Using the fiber focal stick, adjust to exact focal length.
(f) Adjust Z dimension −0.06″ after exact focal length is determined.

(9) Now it is time to double check the rivet holes on the vellum/firearm part by using the Red Box laser feature:
(a) Select all rivet hole(s) and Click (F1) (this brings up the MARK Dialog Box), Check Individual Border in Mark Dialog Box. Click (F1) (turns on Red Box Feature and starts laser pointer).
(b) Adjust X and Y dimensions until aligned.
(c) Apply Yellow Vinyl Paint Mask:
   (i) Clean the surface of the firearm with Wurth Clean-Prep and a Microfiber Cloth.
   (ii) Apply Yellow Vinyl Paint Mask to the surface of the Firearm Part.
(d) The Red Box laser pointer will actually outline the rivet hole to verify the firearm part is in the correct location.
(e) Repeat Red Box verification until all check points are confirmed. (Rivet hole(s), both outer and inside outline, ejection port, straight edges, four corners etc.)
(f) If adjustments are necessary, move the laser following the XYZ coordinates instructions in (8) above.

(10) Verification of all measurements is now complete. The paint mask is ready to be laser cut.

PHASE 4—Step 2—Now that the Firearm Part is Perfectly Aligned; it is Ready to Laser Cut the Paint Mask.

(1) Make sure the firearm part is in the exact location. Double verify firearm part has NOT MOVED and is still LEVEL.

(2) If firearm part is lined up select the OUTLINE.plt only and laser outline:
(a) Remove FOC-Align Cover from the laser. Put glasses on. Make sure exhaust blower is on.
(b) Click (F1) three times to run the laser. (First click brings up MARK Dialog Box, second click turns on the RED BOX and the third click RUNS the laser.)

(3) Peel mask away.

(4) Close the MARK Dialog Box—Stop>close Red Box.

PHASE 4—Step 3—Laser Ablate the Firearm Part.

(1) Make a COPY of the OUTLINE.plt by clicking (F5):
(a) Change number of passes from five to one under the OBJECT INFO TAB>Apply.
(b) Fill the OUTLINE PLT under the FILL TAB select Enable (change to 90 degree fill with a spacing of 0.0012″ distance)>Apply.
(c) Change Power setting under the LASER TAB to Gun Fill>Apply. (Power 30/Speed 10/Q 20/Spot Size 2—Gun Fill Pen #21.)
(d) Make a copy by clicking (F5) of the above created OUTLINE PLT and change the FILL ANGLE under the FILL TAB to (−45 degree fill)>Apply.
(e) Make a copy by clicking (F5) of the above created OUTLINE PLT and change the FILL ANGLE under the FILL TAB to (0 degree fill)>Apply.
(f) Make a copy by clicking (F5) of the above created OUTLINE PLT and change the FILL ANGLE under the FILL TAB to (45 degree fill)>Apply.

(2) Select all four passes created above and copy them by clicking (F5). A total of eight passes has been created.

(3) Create the final pass (an Outline Pass only with three passes)>Copy the first OUTLINE.PLT by clicking (F5)>Change Passes from five to three under the Object Info Tab>Change the Power Setting to Gun Fill under the Laser Tab.

(4) LASER ENGRAVE—Select all the above created layers>Click the second OUTLINE.PLT file in the left joblist>click Shift then select the last OUTLINE.PLT Layer. Safety glasses on. Click (F1) three times to run the laser: First click brings up MARK dialog box, Second click turns on the RED BOX, and the Third click RUNS the laser.

(5) Clean the surface of the firearm part again with Wurth Clean-Prep and a Microfiber Cloth.

(6) Click STOP>Close (Red X Box).

(7) Save.

(8) PHASE 4 is now complete.

PHASE 5: Using the MIMAKI UV Printer, Color Print the Firearm Part as the FINISH Step.

(1) Install firearm fixture on bed of printer.

(2) Wipe surface of firearm part with Wurth Clean-Prep and put it in the fixture.

(3) Open Mimaki Rasterlink6 on desktop and say YES to pop-up.

(4) Lower table so printer head clears the fixture:
(a) This is done on actual machine.
(b) Function>Down Arrow to Head Height>Enter>Down Arrow to Table Spacer>Enter>(change to 0>Enter>Down Arrow to Media Thickness>Enter>146.3 mm>Enter>END twice to get back to main screen).

(5) Open the ART LAYER.pdf. Click File>Open>ART LAYER.pdf>Open.

(6) Under Joblist scroll down to find the file and click once on it.

(7) In Menu on right hand side go to General Print (ALT+G) (verify Art size matches PhotoShop size on Dimensions Sheet).
(a) Under Scale check Valid Pixel and change size if need be.
(b) Move where the image prints under Position. Position>Change Scan & Feed to correct Dimensions (based on a Scan which is horizontal of 12″ and Feed which is vertical of 9.25″) (Formula: Dimensions of Artwork divided by 2, subtract this from the above-mentioned Scan and Feed and plug that in as the Dimensions for Position) (write down Dimensions to be used in the future). To preview go to the Jig Print (ALT+J). (This gives a visual, if it is necessary to move, repeat above.)

(8) In same menu on right hand side click Quality (ALT+Q) and under Print Quality go to resolution and select 720×1200 VD.

(9) Put clear acrylic cover over firearm part and tape down a piece of inkjet paper on area it is going to print.

(10) In Menu on right hand side click Execution (ALT+X)>Make sure Rip & Print is Selected>click Start.

(11) Put in Remote Mode done on actual machine.

(12) Peel paper after printing.

(13) Create white Layer by importing the WHITE.pdf file:
(a) File>Open>Choose WHITE.pdf>Click Open.
(b) Click on White Color Layer in Joblist.
(c) General Print Tab (ALT+G)>Click Valid.
(d) Change location of art to exact same as Color Layer.
(e) Click Quality (ALT+Q) and change to 720×1200 VD.
(f) Click Properties (ALT+I)>Under Job Attributes change to Mono Color
(g) In Job Attributes dialogue box under Source Color check Cyan>Check White & White>OK.

(14) Create primer Layer by importing the PRIMER.pdf file.
(a) File>Open>Choose PRIMER.pdf>Click Open.
(b) Click on Primer Color Layer in Joblist.
(c) General Print Tab (ALT+G)>Click Valid.
(d) Change location of art to exact same as Color Layer.
(e) Click Quality (ALT+Q) and Change to 720×1200 VD.
(f) Click Properties (ALT+I)>Under Job Attributes change to Mono Color.
(g) In Job Attributes dialogue box under Source color check Magenta>Check Primer>OK.

(15) Double check that all layers match size, resolution and position under General Print (ALT+G) and Quality (ALT+Q).

(16) Tape the Clear Transparency on the fixture over the print area.

(17) Highlight the Primer Layer in Joblist and run the Primer Layer to make sure firearm is straight.

(18) In menu on right hand side click Execution (ALT+X) and click Rip and Print for Primer Layer ONLY>Start.

(19) Use fixture to align firearm part to primer print.

(20) Remove acrylic printing surface and all spacers. (Make sure Firearm Part is still level.)

(21) Lower table so printer head clears the firearm part:
(a) Done on actual machine.
(b) Put machine in Local Mode by hitting Remote Button.
(c) Function>Down Arrow to Head Height>Enter>Down Arrow to Media Thickness>Enter>TBD MM.
(d) Put MM Dimension on Dimensions Sheet.
(e) Verify nothing is sticking up (including yellow mask).
(f) Put black plastic piece in front of firearm so printer has something to see.
(g) Put in Remote Mode (done on actual machine). Make sure laser does a Micro Adjustment to verify focal length is accurate, otherwise it will need to be adjusted.

(22) Choose Print Only and click Start. After primer has printed, make sure it is printed centered on ablated surface. (If not make adjustments.)

(23) Select White Layer Only and click (ALT+X), Rip & Print, Start.
(a) Verify white is solid/bright enough, will probably have to run multiple times.
(b) To repeat click print only then start (or the black button).
(c) On dimensions sheet write down how many passes were run.

(24) Select Art Layer Only and the click (ALT+X), Rip & Print, and then click Start.

(25) Release vacuum and remove firearm part.

(26) Peel mask.

(27) PHASE 5 is now complete.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

We claim:

1. A customized surface of a firearm, comprising:
a laser ablated portion of a metal surface of the firearm; and
a printed ink image within the boundaries of said laser ablated portion of said metal surface of said firearm.

2. A customized surface of a firearm as set forth in claim 1, wherein:
said laser ablated portion of a metal surface is outside the bounds of any rivets and markings on the surface of the firearm.

3. A customized surface of a firearm as set forth in claim 1, wherein:
said laser ablated portion includes a textured surface created by a plurality of laser ablation cuts from different directions.

4. A customized surface of a firearm as set forth in claim 3, wherein:
said printed ink imager is slightly larger than said laser ablated portion.

5. A customized surface of a firearm as set forth in claim 4, wherein:
said printed ink image includes a picture.

6. A customized surface of a firearm as set forth in claim 5, wherein:
said printed ink image includes text.

7. A customized surface of a firearm as set forth in claim 6, wherein:
said printed ink image includes color.

8. A method for customizing the surface of a firearm, comprising:
selecting a metal portion of the firearm for an image;
laser ablating said portion of a metal surface of the firearm; and
printing said image on said laser ablated portion of the firearm.

9. A method for customizing the surface of a firearm as set forth in claim 8, including:
selecting an image;
taking a picture of the surface of the firearm;
determining the size of the image to fit on the surface of the firearm; and
adjusting the size and aspect ratio of the image so that it fits on said surface.

10. A method for customizing the surface of a firearm as set forth in claim 9, wherein:
said size determining step includes ensuring that the image does not overlap with any rivets or pre-existing markings on the surface of the firearm.

11. A method for customizing the surface of a firearm as set forth in claim 10, wherein:
said laser ablation step includes laser ablating said portion from multiple different directions.

12. A method for customizing the surface of a firearm as set forth in claim 11, wherein:
said printing step includes using an inkjet printer.

13. A method for customizing the surface of a firearm as set forth in claim 10, wherein:
said size determining step includes using another object with a known dimension to confirm the sizing of the image for said surface of the firearm.

14. A method for customizing the surface of a firearm as set forth in claim 9, including:
preparing a mask to be placed over the surface of the firearm that includes an aperture that is slightly smaller than said determined image size.

15. A method for customizing the surface of a firearm as set forth in claim 14, wherein:
said mask is used in both the laser ablation and image printing steps.

16. A method for customizing the surface of a firearm as set forth in claim 8, wherein:
said image printing step includes printing the image so that it is slightly larger than said laser ablated portion.

17. A fixture for use in the customization of the surface of a firearm, comprising:
a generally flat surface sized to receive a portion of a firearm and to fit under the heads of a laser ablation machine and an ink printer;
at least one adjustable support leg;
an adjustment member for moving said generally flat surface along one axis;
an adjustment member for moving said generally flat surface along another axis; and
a level member for confirming that said generally flat surface is level when it is under said heads of a laser and ink printer.

18. A fixture for use in the customization of a firearm as set forth in claim 17, wherein:
said level member is a detachable bubble level.

19. A fixture for use in the customization of a firearm as set forth in claim 18, wherein:
said adjustment members are threadably attached to a base that supports said at least one adjustable support leg to move said generally flat surface along the different respective axes.

20. A fixture for use in the customization of a firearm as set forth in claim 17, including:
at least one fixed support leg.
